(19) United States
(12) Patent Application Publication
(10) Pub. No.: US 2025/0287312 A1
(43) Pub. Date: Sep. 11, 2025

(54) LOW BANDWIDTH LISTEN FOR WIRELESS COMMUNICATIONS

(71) Applicant: Synaptics Incorporated, San Jose, CA (US)

(72) Inventor: Mohan Ramasudha Karnam, San Jose, CA (US)

(73) Assignee: Synaptics Incorporated, San Jose, CA (US)

(21) Appl. No.: 18/597,471

(22) Filed: Mar. 6, 2024

(51) Int. Cl. H04W 52/02; H04B 17/318

(52) U.S. Cl. CPC H04W 52/0238; H04B 17/318

(57) ABSTRACT

This disclosure provides methods, devices, and systems for wireless communications. The present implementations more specifically relate to reducing the power consumption of radio frequency (RF) receivers when listening to a wireless channel. In some aspects, a wireless communication device may receive an RF signal over a wireless channel, down-covert the RF signal to baseband, and convert the baseband signal to the digital domain via an analog-to-digital converter (ADC) configured to sample the baseband signal at one of multiple sampling rates based, at least in part, on whether adjacent channel interference (ACI) is determined to be present in the received signal. For example, the wireless communication device may configure the ADC to sample at a lower rate when ACI is determined to be absent and sample at a higher rate when ACI is determined to be present, or when a packet is detected in the received signal.

### TECHNICAL FIELD

The present implementations relate generally to wireless communication, and specifically to low bandwidth listen techniques for wireless communications.

### BACKGROUND OF RELATED ART

Wireless communication devices rely on radio frequency (RF) transmitters and receivers (also referred to as “wireless radios”) to communicate with other devices over a wireless communication channel. An RF transmitter modulates data or other information onto a carrier wave and upconverts the modulated waveform to a radio frequency (such as 2.4 GHz), for example, by mixing the modulated waveform with a local oscillator (LO) signal that oscillates at the radio frequency. The resulting RF signal is further amplified by a power amplifier for transmission over the wireless channel via one or more antennas. An RF receiver receives the RF signal via one or more antennas and amplifies the received signal via a low-noise amplifier (LNA). The RF receiver mixes the received signal with another LO signal, which oscillates at the radio frequency, to recover the modulated waveform (also referred to as the “baseband signal”) and further converts the baseband signal from the analog domain to the digital domain, using an analog-to-digital converter (ADC), for further processing.

RF receivers often spend a significant amount of time operating in a “listen mode,” where the receiver listens to the wireless channel for wireless communications from other wireless communication devices. While operating in the listen mode, an RF receiver continues to draw current and power from the wireless communication device even when no incoming communications are received. Because many wireless communication devices are battery-operated devices, with limited power budgets, there is a need to reduce the power consumption of RF receivers when operating in the listen mode.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method performed by a wireless communication device. The method includes receiving a first signal via a wireless communication channel; determining whether adjacent channel interference (ACI) is present in the first signal based on one or more signals previously received by the wireless communication device via the wireless communication channel; and configuring an analog-to-digital converter (ADC) to sample the first signal at one of a plurality of sampling rates based at least in part on whether ACI is determined to be present in the first signal, where the ADC produces a digital signal based on the sampling of the first signal.

Another innovative aspect of the subject matter of this disclosure can be implemented in a wireless communication device including a processing system and a memory. The memory stores instructions that, when executed by the processing system, causes the wireless communication device to receive a first signal via a wireless communication channel; determine whether ACI is present in the first signal based on one or more signals previously received by the wireless communication device via the wireless communication channel; and configure an ADC to sample the first signal at one of a plurality of sampling rates based at least in part on whether ACI is determined to be present in the first signal, where the ADC produces a digital signal based on the sampling of the first signal.

### BRIEF DESCRIPTION OF THE DRAWINGS

The present implementations are illustrated by way of example and are not intended to be limited by the figures of the accompanying drawings.

FIG. 1 shows an example wireless communication system.

FIG. 2 shows a block diagram of an example radio frequency (RF) receiver, according to some implementations.

FIG. 3 shows a block diagram of an example controller for an RF receiver, according to some implementations.

FIG. 4 shows a timing diagram depicting an example wireless communication between a transmitting device and a receiving device, according to some implementations.

FIG. 5 shows a block diagram of an example wireless communication device, according to some implementations.

FIG. 6 shows an illustrative flowchart depicting an example operation for wireless communication, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems or devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

Aspects of the present disclosure can be implemented by any device, system, or network that is capable of receiving radio frequency (RF) signals, such as in accordance with one or more Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, or 5G (New Radio (NR)) standards promulgated by the 3rd Generation Partnership Project (3GPP), among others. Aspects of the present disclosure can be implemented by any device, system, or network that is capable of receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO), and multi-user (MU) MIMO. Aspects of the present disclosure also can be implemented using other wireless communication protocols or RF signals suitable for use in one or more of a wireless personal area network (WPAN), a wireless local area network (WLAN), a wireless wide area network (WWAN), or an Internet of Things (IoT) network.

As described above, wireless communication devices rely on radio frequency (RF) transmitters and receivers (also referred to as “wireless radios”) to communicate with other devices over a wireless communication channel. An RF transmitter modulates data or other information onto a carrier wave and upconverts the modulated waveform to a radio frequency, for example, by mixing the modulated waveform with a local oscillator (LO) signal that oscillates at the radio frequency. The resulting RF signal is further amplified by a power amplifier for transmission over the wireless channel via one or more antennas. An RF receiver receives the RF signal via one or more antennas and amplifies the received signal via a low-noise amplifier (LNA). The RF receiver mixes the received signal with another LO signal, which oscillates at the radio frequency, to recover the modulated waveform (also referred to as the “baseband signal”) and further converts the baseband signal from the analog domain to the digital domain, using an analog-to-digital converter (ADC), for further processing.

Many RF receivers include low-pass filters (LPFs) that filter or suppress noise and interference, including adjacent channel interference (ACI), in the analog baseband signal. However, a substantial portion of the ACI is often filtered in the digital domain (using a digital filter) due to various factors such as die size and power requirements. To support digital filtering of the ACI, the ADC must sample the baseband signal at a sampling rate greater than or equal to twice the Nyquist frequency (such as to prevent the ACI from folding back into the baseband). Aspects of the present disclosure recognize that the current or power consumed by an ADC is directly proportional to its sampling rate. In other words, an ADC draws more current when sampling at a higher sampling rate than when sampling at a lower sampling rate. Thus, aspects of the present disclosure further recognize that the power consumption of an RF receiver can be reduced by lowering the sampling rate of an ADC when no incoming communications are being received (such as in a “listen mode”).

Various aspects relate generally to wireless communications, and more particularly, to reducing the power consumption of RF receivers when listening to a wireless communication channel. In some aspects, a wireless communication device (or RF receiver) may receive an RF signal over a wireless communication channel, down-covert the RF signal to baseband, and convert the baseband signal to the digital domain via an ADC configured to sample the baseband signal at one of multiple sampling rates based, at least in part, on whether ACI is determined (or expected) to be present in the received signal. For example, the wireless communication device may configure the ADC to sample at a lower rate when ACI is expected to be absent and sample at a higher rate when ACI is expected to be present, or when a packet is detected in the received signal. In some implementations, the wireless communication device may further include a digital ACI filter that is configured to suppress ACI in the digital signal when the ADC samples at the higher rate and is bypassed when the ADC samples at the lower rate.

Particular implementations of the subject matter described in this disclosure can be implemented to realize one or more of the following potential advantages. By dynamically adjusting the sampling rate of an ADC based on whether ACI is determined or expected to be present in a received signal, aspects of the present disclosure can optimize the power consumption of an RF receiver operating in the listen mode. For example, when ACI is expected to be absent from a received signal, the wireless communication device may bypass the digital ACI filter with little or no risk of losing any information carried on the received signal. In such instances, the wireless communication device also may lower the sampling rate of the ADC (such as below twice the Nyquist frequency) to reduce the power consumption of the RF receiver. On the other hand, when ACI is expected to be present in a received signal (or a packet is detected), the wireless communication device may raise the sampling rate of the ADC to enable the digital ACI filter to suppress the ACI in the digital signal.

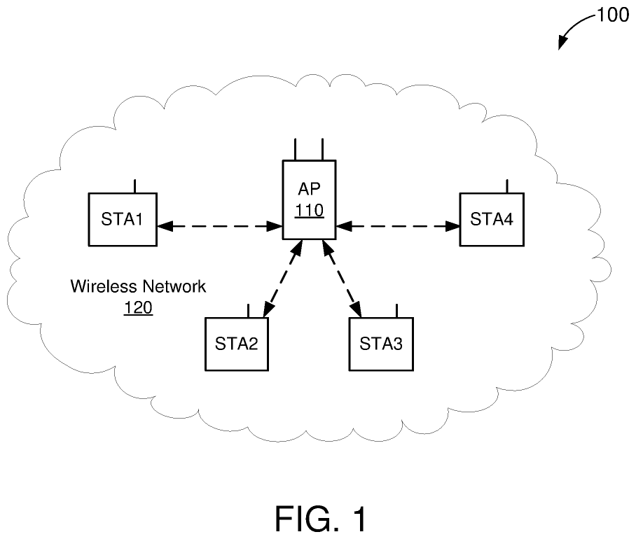

FIG. 1 shows an example wireless communication system 100. The system 100 is shown to include a wireless access point (AP) 110 and four wireless stations STA1-STA4. Although one AP and four wireless stations (STAs) are shown in the example of FIG. 1, the wireless communication system 100 may include any number of APs and any number of STAs.

The wireless stations STA1-STA4 may include any suitable wireless communication device including, among other examples, a cell phone, a personal digital assistant (PDA), a table device, or other personal computing device. A STA also may be referred to as a user equipment (UE), a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, or some other suitable terminology. Each of the wireless stations STA1-STA4 may include one or more radio frequency (RF) transceivers, one or more processing resources (such as processors or ASICs), one or more memory resources, and a power source (such as a battery).

The AP 110 may be any suitable device that allows one or more wireless communication devices to connect to a wireless network 120 (such as a local area network (LAN), a wide area network (WAN), metropolitan area network (MAN), or the Internet, among other examples) using Wi-Fi, Bluetooth, or any other suitable wireless communication standards. In some aspects, the wireless network 120 may be a WLAN, such as a Wi-Fi network. For example, the wireless network 120 may implement at least one of the IEEE 802.11 family of wireless communication protocol standards. In some implementations, the AP 110 may be any suitable wireless communication device (such as a STA) acting as a software-enabled access point (SoftAP). The AP 110 may include one or more RF transceivers, one or more processing resources (such as processors or ASICs), one or more memory resources, and a power source (such as a battery).

For the stations STA1-STA4 and the AP 110, the one or more transceivers may include Wi-Fi transceivers, Bluetooth transceivers, cellular transceivers, and any other suitable RF transmitters or receivers to transmit or receive wireless communication signals. Each transceiver may communicate with other wireless devices in distinct operating frequency bands, using distinct communication protocols, or both. For example, the Wi-Fi transceiver may communicate within a 900 MHz frequency band, a 2.4 GHz frequency band, a 5 GHz frequency band, a 6 GHz frequency band, and a 60 MHz frequency band in accordance with the IEEE 802.11 standards. The Bluetooth transceiver may communicate within the 2.4 GHz frequency band in accordance with the standards provided by the Bluetooth Special Interest Group (SIG), in accordance with the IEEE 802.15 standards, or both. The cellular transceiver may communicate within various RF frequency bands in accordance with any suitable cellular communications standard.

In some aspects, access to the shared wireless medium may be governed by a distributed coordination function (DCF), such as carrier sense multiple access with collision avoidance (CSMA/CA), according to the IEEE 802.11 standard. With CSMA/CA, there is generally no centralized master device allocating time and frequency resources of the shared wireless medium. Rather, any wireless communication device (including APs or STAs) attempting to transmit data must wait a random backoff (RBO) duration and contend for access to the wireless medium. More specifically, after the RBO duration expires, a wireless communication device must perform a clear channel assessment (CCA) and determine that the desired wireless channel is idle before it can transmit a communications packet, such as a physical layer convergence protocol (PLCP) protocol data unit (PPDU), on that channel.

When a wireless communication device is not actively transmitting or receiving on a wireless channel, the device is often “listening” to the channel for communications from other wireless communication devices (such as to detect incoming communications or to contend for medium access). While operating in the listen mode, the RF receiver draws current or power from the wireless communication device, even when the channel is idle. Aspects of the present disclosure recognize that a significant portion of the power is consumed by an analog-to-digital converter (ADC) which converts received signals to the digital domain. Aspects of the present disclosure further recognize that the current or power consumed by an ADC is proportional to its sampling rate. In other words, an ADC draws more current when sampling at a higher sampling rate than when sampling at a lower sampling rate. In some aspects, a wireless communication device (such as an AP or a STA) may dynamically adjust the sampling rate of one or more ADCs implemented by its RF receivers based, at least in part, on whether the receivers are operating in the listen mode.

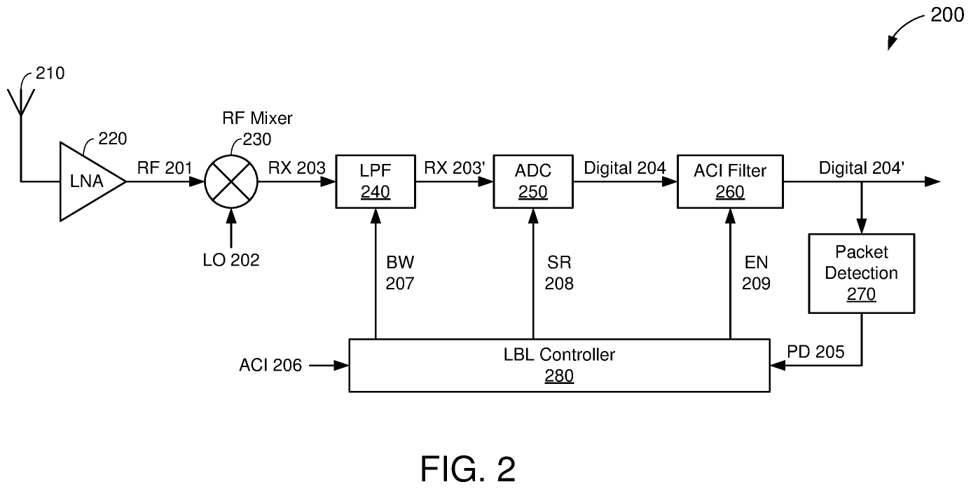

FIG. 2 shows a block diagram of an example RF receiver 200, according to some implementations. The RF receiver 200 is configured to receive RF signals 201, on behalf of a wireless communication device, over a wireless communication channel. In some implementations, the wireless communication device may be an AP or a STA such as the AP 110 or any of the wireless stations STA1-STA4 of FIG. 1.

The RF receiver 200 includes a low-noise amplifier (LNA) 220, an RF mixer 230, a low-pass filter (LPF) 240, an ADC 250, an adjacent channel interference (ACI) filter 260, a packet detection component 270, and a low-bandwidth listen (LBL) controller 280. The LNA 220 amplifies the RF signal 201 received via one or more antennas 210, and the RF mixer 230 down-converts the RF signal 201 to a baseband (RX) signal 203. For example, the RF mixer 230 may demodulate the RF signal 203 based on a local oscillator (LO) signal 202 that oscillates at a carrier frequency (or RF).

The LPF 240 is configured to remove or suppress noise and interference in the RX signal 203 by passing a subset of frequencies of the RX signal 203, as a filtered RX signal 203′, to the ADC 250. For example, the LPF 240 may attenuate frequencies of the RX signal 203 that are higher (or lower) than a cutoff frequency. The range of frequencies passed by the LPF 240 (such as the subset of frequencies associated with the filtered RX signal 203′) may represent a “bandwidth” of the LPF 240. In other words, the bandwidth of the LPF 240 may be defined by its upper (and lower) cutoff frequency.

The ADC 250 converts the filtered RX signal 203′ to a series of discrete time-domain samples, representing a digital signal 204, that can be processed in the digital domain. The resolution or granularity of the digital samples depends on the sampling rate of the ADC 250. The ACI filter 260 is a digital filter configured to filter or remove residual ACI in the digital signal 204 (such as any ACI that was not removed by the LPF 240). To support ACI filtering in the digital domain, the ADC 250 must sample the filtered RX signal 203′ at a sampling rate greater than or equal to the Nyquist frequency (such as to prevent the ACI from folding back into baseband).

As described with reference to FIG. 1, the current or power consumed by the ADC 250 is directly proportional to its sampling rate. In other words, the ADC 250 draws more current when sampling at a higher sampling rate than when sampling at a lower sampling rate. However, in existing wireless communication devices (and existing RF receivers and transceivers), ADCs have relatively high sampling rates that are preconfigured to support ACI filtering in the digital domain even when ACI is not present or when no incoming communications are being received (such as when operating in a listen mode).

In some aspects, the LBL controller 280 may dynamically control a sampling rate (SR) 208 of the ADC 250 based, at least in part, on whether ACI is present (or absent) in the RF signal 201. More specifically, the LBL controller 280 may receive or monitor one or more ACI parameters 206 associated with previously received RF signals to determine whether ACI is expected to be present in the RF signal 201. Example suitable ACI parameters include, among other examples, a received signal strength indication (RSSI) associated with the RF signals (or other measure of the total signal power) and an amount of power in the digital signals resulting from the analog-to-digital conversion (or other measure of the in-band signal power).

In some implementations, the LBL controller 280 may reduce the sampling rate 208 of the ADC 250 in response to determining that ACI is absent from the RF signal 201 (for at least a threshold duration). For example, the LBL controller 280 may reduce the sampling rate 208, from a sampling rate greater than or equal to twice the Nyquist frequency to a sampling rate less than twice the Nyquist frequency, in response to determining that ACI is absent from the RF signal 201. In such implementations, the LBL controller 280 may further disable (or bypass) the ACI filter 260, via an enable (EN) signal 209, so that the ACI filter 260 passes the digital signal 204 through, unaltered, as a digital output 204′. For example, the LBL controller 280 may deassert the EN signal 209, which causes the ACI filter 260 to refrain from filtering the digital signal 204.

As used herein, the term “low-bandwidth listen” (LBL) mode refers to a state of the RF receiver 200 where the ADC 250 operates with a reduced sampling rate 208 and the ACI filter 260 is bypassed or disabled. Aspects of the present disclosure recognize that the presence of ACI may hinder the ability of the wireless communication device to demodulate or recover any information carried in the digital signal 204′. In some implementations, the LBL controller 280 may further deactivate the LBL mode, such as by increasing or restoring the sampling rate 208 of the ADC 250 and re-enabling the ACI filter 260, in response to determining that ACI is present in the RF signal 201. When the ACI filter 260 is enabled (such as by asserting the EN signal 209), the ACI filter 260 may filter or remove ACI from the digital output 204′.

Aspects of the present disclosure further recognize that the ACI parameters 206 associated with previously received RF signals may not accurately reflect the amount of ACI in the current RF signal 201 (which can be higher than estimated). Inn some implementations, the LBL controller 280 also may deactivate the LBL mode in response to detecting a packet carried on the digital output 204′. For example, the packet detection component 270 may be configured to detect communication packets conforming to one or more wireless communication standards (such as PPDUs). In some implementations, the packet detection component 270 may output a packet detection (PD) signal 205 indicating whether a packet is detected in the digital output 204′. If the PD signal 205 indicates that a packet is detected while the RF receiver 200 is operating in the LBL mode, the LBL controller 280 may deactivate the LBL mode even if the ACI parameters 206 indicate an absence of ACI.

In some implementations, the LBL controller also may control a bandwidth (BW) 207 of the LPF 240 based on whether the RF receiver 200 operates in the LBL mode. More specifically, the LBL controller 280 may reduce the bandwidth 207 of the LPF 240 in response to activating the LBL mode (such as when ACI is determined to be absent from the RF signal 201 while no packet is detected in the digital output 204′). Reducing the bandwidth 207 of the LPF 240 can improve the signal-to-noise ratio (SNR) of the filtered RX signal 203′, which improves the accuracy of packet detection by the packet detection component 270. The LBL controller 280 may subsequently increase or restore the bandwidth 207 of the LPF 240 in response to deactivating the LBL mode (such as when ACI is determined to be present in the RF signal 201 or a packet is detected in the digital output 204′).

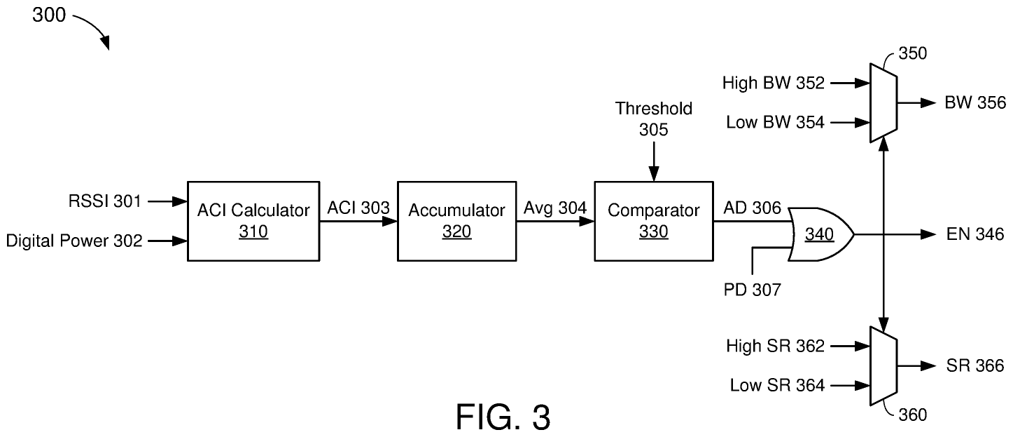

FIG. 3 shows a block diagram of an example controller 300 for an RF receiver, according to some implementations. In some implementations, the controller 300 may be one example of the LBL controller 280 of FIG. 2. More specifically, the controller 300 is configured to control a bandwidth (BW) 356 of an LPF and a sampling rate (SR) 366 of an ADC and to selectively enable (or disable) an ACI filter via an enable (EN) signal 346. With reference to FIG. 2, LPF, ADC, and ACI filter may be examples of the LPF 240, ADC 250, and ACI filter 260, respectively. Thus, the signals BW 356, SR 366, and EN 346 may be examples of the signals BW 207, SR 208, and EN 209, respectively, of FIG. 2.

The controller 300 includes an ACI calculator 310, an accumulator 320, and a comparator 330. The ACI calculator 310 is configured to calculate or produce an ACI value 303 based on an RSSI 301 of an RF signal previously received by the RF receiver and an amount of digital power 302 in the RF signal after conversion to the digital domain (such as the digital signal 204 of FIG. 2). The RSSI 301 and the digital power 302 can be measured or estimated by a wireless communication device using any known system or technique. With reference to FIG. 2, the RSSI 301 and digital power 302 may be examples of the ACI parameters 206. In some implementations, the ACI value 303 may be a ratio of the total power of the RF signal (as a function of the RSSI 301) to the in-band power of the RF signal (as a function of the digital power 302).

The accumulator 320 stores or accumulates the ACI values 303 over a threshold duration (such as a number (N) of the most recent ACI values 303). In some implementations, the accumulator 320 may further calculate or maintain a running average (avg) 304 of the N most recent ACI values 303. The comparator 330 compares the running average 304 to a threshold 305 and produces an ACI detection (AD) signal 306 based on the comparison. In some implementations, the AD signal 306 may indicate whether ACI is determined to be present in an RF signal currently received by the RF receiver. For example, the comparator 330 may assert the AD signal 306, to a logic-high state, if the running average 304 exceeds the threshold 305 (indicating a presence of ACI) and may deassert the AD signal 306, to a logic-low state, if the running average 304 is below the threshold 305 (indicating an absence of ACI).

The AD signal 306 is provided, together with a packet detection (PD) signal 307, as inputs to a logic gate 340. The PD signal 307 indicates whether a packet is detected in the RF signal currently received by the RF receiver. With reference to FIG. 2, the PD signal 307 may be one example of the PD signal 205 output by the packet detection component 270. For example, the PD signal 307 may be asserted, to a logic-high state, when a packet is detected in the current RF signal and may be deasserted, to a logic-low state, when no packet is detected in the current RF signal. The logic gate 340 produces the EN signal 346 based on a logical combination of the AD signal 306 and the PD signal 307. In the example of FIG. 3, the logic gate 340 is shown to implement OR logic.

More specifically, the logic gate 340 deasserts the EN signal 346, to a logic-low state, only when the AD signal 306 and the PD signal 307 are concurrently deasserted (indicating that ACI is not present, nor is any packet detected, in the current RF signal). However, if either the AD signal 306 or the PD signal 307 is asserted (indicating that ACI is present or a packet is detected in the current RF signal), the logic gate 340 also asserts the EN signal 346, such as to a logic-high state. As described with reference to FIG. 2, the controller 300 may enable or otherwise cause the ACI filter 260 to remove ACI in the digital signal 204 by asserting the EN signal 346 (to the logic-high state) and may disable, or otherwise cause the digital signal 204 to bypass, the ACI filter 260 by deasserting the EN signal 346 (to the logic-low state).

The EN signal 346 is also used to control the outputs of a set of multiplexers 350 and 360. The first multiplexer 350 receives a high BW signal 352 and a low BW signal 354 as its inputs and selects one of the input signals 352 or 354 for output, as the BW signal 356, based on the state of the EN signal 346. With reference for example to FIG. 2, high BW signal 352 may cause the LPF 240 to attenuate any frequencies in the RF signal 201 above a first cutoff frequency (such as 10 MHZ), whereas the low BW signal 354 may cause the LPF 240 to attenuate any frequencies in the RX signal 203 above a second cutoff frequency that is lower than the first cutoff frequency (such as 6.5 MHZ). In some implementations, the first multiplexer 350 may output the high BW signal 352, as the BW signal 356, when the EN signal 346 is asserted (to the logic-high state) and may output the low BW signal 354, as the BW signal 356, when the EN signal 346 is deasserted (to the logic-low state).

The second multiplexer 360 receives a high SR signal 362 and a low SR signal 364 as its inputs and selects one of the input signals 362 or 364 for output, as the SR signal 366, based on the state of the EN signal 346. With reference for example to FIG. 2, the high SR signal 362 may cause the ADC 250 to sample the filtered RX signal 203′ at a sampling rate greater than or equal to twice the Nyquist frequency (such as 40 MHZ), whereas the low SR signal 364 may cause the ADC 250 to sample the filtered RX signal 203′ at a lower sampling rate which can be less than twice the Nyquist frequency (such as 20 MHZ). In some implementations, the second multiplexer 360 may output the high SR signal 362, as the SR signal 366, when the EN signal 346 is asserted (to the logic-high state) and may output the low SR signal 364, as the SR signal 366, when the EN signal 346 is deasserted (to the logic-low state).

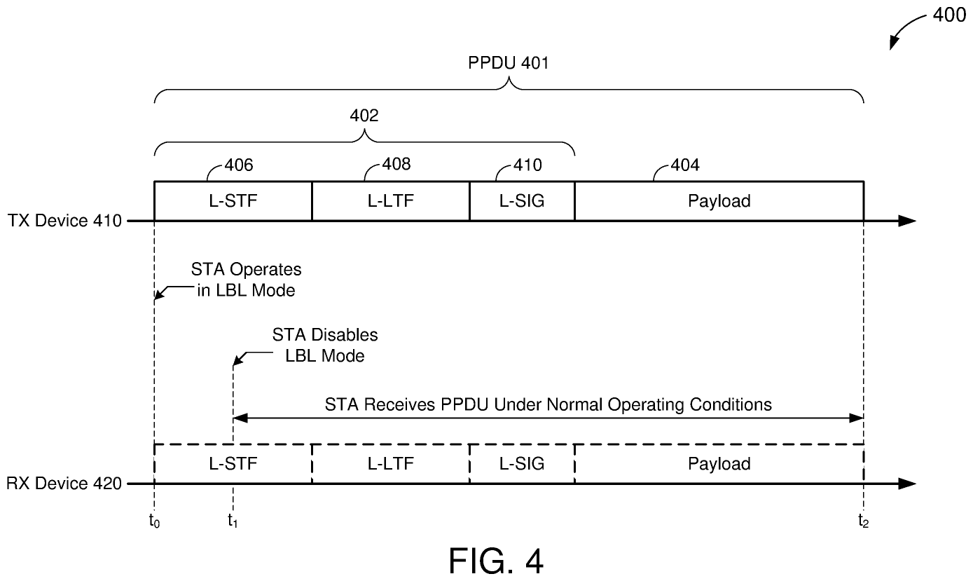

FIG. 4 shows a timing diagram 400 depicting an example wireless communication between a transmitting (TX) device 410 and a receiving (RX) device 420, according to some implementations. In some implementations, the TX device 410 may be one example of the AP 110 or any of the wireless stations STA1-STA4 of FIG. 1. In some implementations, the RX device 420 may be one example of the AP 110 or any of the wireless stations STA1-STA4 of FIG. 1.

The TX device 410 transmits a PPDU 401 between times t₀ and t₂. A PPDU is communications packet conforming to the IEEE 802.11 standard. The PPDU format is a composite structure that includes a physical layer (PHY) preamble 402 and a payload 404 in the form of a PHY service data unit (PSDU). The information provided in the PHY preamble 402 may be used by a receiving device (such as the RX device 420) to decode the subsequent data in the PSDU. The PSDU may represent or “carry” one or more medium access control (MAC) protocol data unit (MPDU) frames. Each MPDU frame includes a MAC header followed by the data portion (also referred to as the “payload” or “frame body”) of the MPDU frame.

As shown in FIG. 4, the PHY preamble 402 includes a legacy short training field (L-STF) 406, a legacy long training field (L-LTF) 408, and a legacy signaling field (L-SIG) 410. In some implementations, the PHY preamble 402 also may include a non-legacy portion (not shown for simplicity). The L-STF 406 may be used by the RX device 420 to perform automatic gain control (AGC) and coarse timing and frequency estimation. The L-LTF 408 may be used by the RX device 420 to perform fine timing and frequency estimation and also to estimate the wireless channel. The L-SIG 410 may be used by the RX device 420 to determine a duration of the PPDU 401 and use the determined duration to avoid transmitting on top of the PPDU 401.

In the example of FIG. 4, the RX device 420 is configured to operate in the LBL mode at (or prior to) time to. With reference for example to FIG. 2, the LBL controller 280 may select a low bandwidth 207 for the LPF 240 and a low sampling rate 208 for the ADC 250, while also disabling or bypassing the ACI filter 260 (such as by deasserting the EN signal 209). The RX device 420 receives an RX signal carrying the PPDU 401, at time to, and detects the L-STF 406 (as well as the PPDU 401) at time t₁. With reference for example to FIG. 2, the packet detection component 270 may detect the L-STF in the digital output 204′ and assert the PD signal 205.

In response to detecting the L-STF, at time t₁, the RX device 420 immediately disables the LBL mode. With reference for example to FIG. 2, the LBL controller 280 may select a high bandwidth 207 for the LPF 240 and a high sampling rate 208 for the ADC 250, while also enabling the ACI filter 260 (such as by asserting the EN signal 209) or otherwise causing the ACI filter 260 to remove ACI in the digital signal 204. As a result, the RX device 420 may receive the remainder of the PPDU 401, from times t₁ to t₂, under normal operating conditions.

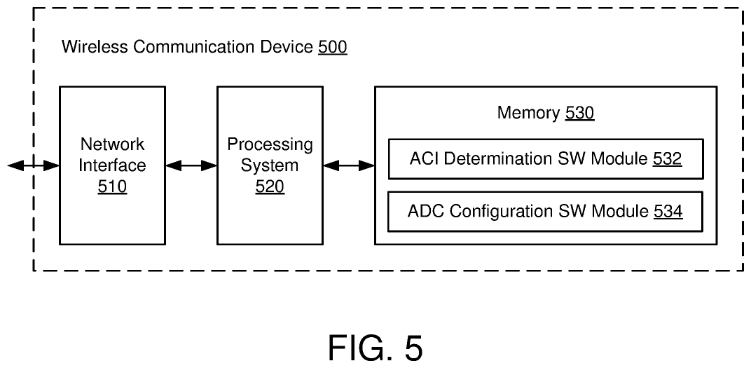

FIG. 5 shows a block diagram of an example wireless communication device 500, according to some implementations. The wireless communication device 500 can be a chip, system-on-a-chip (SoC), chipset, package, or device that includes at least one processor and at least one modem. In some implementations, the wireless communication device 500 may be one example of the AP 110 or any of the wireless stations STA1-STA4 of FIG. 1. In some other implementations, the wireless communication device 500 may be one example of an LBL controller such as the LBL controller 280 or the controller 300 of FIGS. 2 and 3, respectively.

The wireless communication device 500 includes a network interface 510, a processing system 520, and a memory 530. The network interface 510 is configured to communicate with one or more other wireless communication devices. In some implementations, the network interface 510 may receive a wireless signal via a wireless communication channel.

The memory 530 may include a non-transitory computer-readable medium (including one or more nonvolatile memory elements, such as EPROM, EEPROM, Flash memory, or a hard drive, among other examples) that may store at least the following software (SW) modules:
an ACI determination SW module 532 to determine whether ACI is present in the received signal based on one or more signals previously received by the wireless communication device via the wireless communication channel; and
an ADC configuration SW module 534 to configure an ADC to sample the received signal at one of a plurality of sampling rates based at least in part on whether ACI is determined to be present in the received signal, where the ADC produces a digital signal based on the sampling of the received signal.

Each software module includes instructions that, when executed by the processing system 520, causes the wireless communication device 500 to perform the corresponding functions.

The processing system 520 may include any suitable one or more processors capable of executing scripts or instructions of one or more software programs stored in the wireless communication device 500 (such as in the memory 530). For example, the processing system 520 may execute the ACI determination SW module 532 to determine whether ACI is present in the received signal based on one or more signals previously received by the wireless communication device via the wireless communication channel. The processing system 520 also may execute the ADC configuration SW module 534 to configure an ADC to sample the received signal at one of a plurality of sampling rates based at least in part on whether ACI is determined to be present in the received signal, where the ADC produces a digital signal based on the sampling of the received signal.

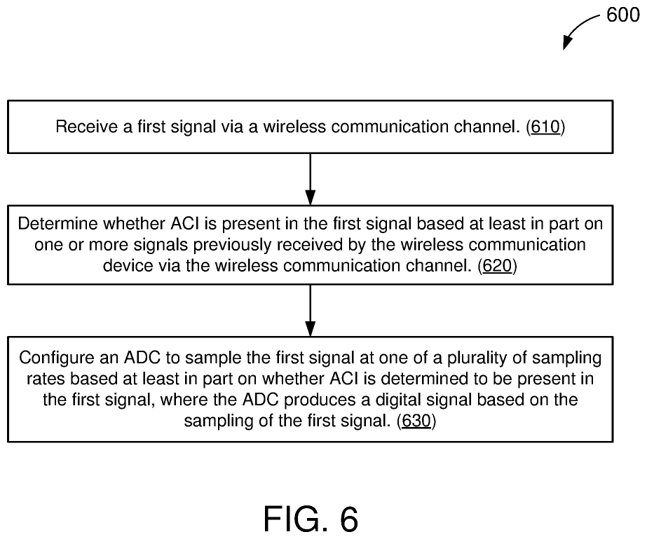

FIG. 6 shows an illustrative flowchart depicting an example operation 600 for wireless communication, according to some implementations. In some implementations, the example operation 600 may be performed by a wireless communication device such as the AP 110 or any of the wireless stations STA1-STA4 of FIG. 1 or the controller 300 of FIG. 3. In some other implementations, the example operation 600 may be performed by an LBL controller such as the LBL controller 280 or the controller 300 of FIGS. 2 and 3, respectively.

The wireless communication device receives a first signal via a wireless communication channel (610). The wireless communication device determines whether ACI is present in the first signal based on one or more signals previously received by the wireless communication device via the wireless communication channel (620). The wireless communication device further configures an ADC to sample the first signal at one of a plurality of sampling rates based at least in part on whether ACI is determined to be present in the first signal, where the ADC produces a digital signal based on the sampling of the first signal (630).

In some aspects, the configuring of the ADC may include configuring the ADC to sample the first signal at a first sampling rate of the plurality of sampling rates responsive to determining that ACI is present in the first signal, and configuring the ADC to sample the first signal at a second sampling rate of the plurality of sampling rates responsive to determining that ACI is not present in the first signal, the second sampling rate being lower than the first sampling rate.

In some aspects, the wireless communication device may further selectively filter the digital signal via a digital filter based on whether the ADC is configured to sample the first signal at the first sampling rate or the second sampling rate, where the digital filter is configured to remove ACI in the digital signal. In some implementations, the selective filtering of the first digital signal may include filtering the digital signal via the digital filter responsive to configuring the ADC to sample the first signal at the first sampling rate, and refraining from filtering the digital signal via the digital filter responsive to configuring the ADC to sample the first signal at the second sampling rate.

In some aspects, the wireless communication device may further detect a packet carried on the first signal and adjust a sampling rate of the ADC responsive to detecting the packet. In some implementations, the adjusting of the sampling rate of the ADC may include changing the sampling rate of the ADC from the second sampling rate to the first sampling rate. In some implementations, the packet may be a PPDU having an L-STF, and the sampling rate of the ADC may be adjusted responsive to detecting the L-STF.

In some aspects, the first signal may be filtered via a low-pass filter. In some implementations, the wireless communication device may further configure a bandwidth of the low-pass filter based on whether ACI is determined to be present in the first signal. In some implementations, the configuring of the bandwidth of the low-pass filter may include configuring the low-pass filter to attenuate frequencies higher than a first cutoff frequency responsive to determining that ACI is present in the first signal, and configuring the low-pass filter to attenuate frequencies higher than a second cutoff frequency responsive to determining that ACI is not present in the first signal, where the second cutoff frequency is lower than the first cutoff frequency.

In some aspects, the wireless communication device may further determine an RSSI associated with the first signal, estimate an amount of power in the digital signal, and calculate an ACI value based on the RSSI and the estimated amount of power in the digital signal. In some implementations, the wireless communication device may further receive a second signal via the wireless communication channel; determine whether ACI is present in the second signal based at least in part on whether the ACI value exceeds a threshold value; and configure the ADC to sample the second signal at one of the plurality of sampling rates based at least in part on whether ACI is determined to be present in the second signal.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for wireless communication by a wireless communication device, comprising:
receiving a first signal via a wireless communication channel;
determining whether adjacent channel interference (ACI) is present in the first signal based on one or more signals previously received by the wireless communication device via the wireless communication channel; and
configuring an analog-to-digital converter (ADC) to sample the first signal at one of a plurality of sampling rates based at least in part on whether ACI is determined to be present in the first signal, the ADC producing a digital signal based on the sampling of the first signal.

2. The method of claim 1, wherein the configuring of the ADC comprises:
configuring the ADC to sample the first signal at a first sampling rate of the plurality of sampling rates responsive to determining that ACI is present in the first signal; and
configuring the ADC to sample the first signal at a second sampling rate of the plurality of sampling rates responsive to determining that ACI is not present in the first signal, the second sampling rate being lower than the first sampling rate.

3. The method of claim 2, further comprising:
selectively filtering the digital signal via a digital filter based on whether the ADC is configured to sample the first signal at the first sampling rate or the second sampling rate, the digital filter being configured to remove ACI in the digital signal.

4. The method of claim 3, wherein the selective filtering of the digital signal comprises:
filtering the digital signal via the digital filter responsive to configuring the ADC to sample the first signal at the first sampling rate; and
refraining from filtering the digital signal via the digital filter responsive to configuring the ADC to sample the first signal at the second sampling rate.

5. The method of claim 2, further comprising:
detecting a packet carried on the first signal; and
adjusting a sampling rate of the ADC responsive to detecting the packet.

6. The method of claim 5, wherein the adjusting of the sampling rate of the ADC comprises:
changing the sampling rate of the ADC from the second sampling rate to the first sampling rate.

7. The method of claim 5, wherein the packet comprises a physical layer convergence protocol (PLCLP) protocol data unit (PPDU) having a legacy short training field (L-STF), and the sampling rate of the ADC is adjusted responsive to detecting the L-STF.

8. The method of claim 1, wherein the first signal is filtered via a low-pass filter, the method further comprising:
configuring a bandwidth of the low-pass filter based on whether ACI is determined to be present in the first signal.

9. The method of claim 8, wherein the configuring of the bandwidth of the low-pass filter comprises:
configuring the low-pass filter to attenuate frequencies higher than a first cutoff frequency responsive to determining that ACI is present in the first signal; and
configuring the low-pass filter to attenuate frequencies higher than a second cutoff frequency responsive to determining that ACI is not present in the first signal, the second cutoff frequency being lower than the first cutoff frequency.

10. The method of claim 1, further comprising:
determining a received signal strength indication (RSSI) associated with the first signal;
estimating an amount of power in the digital signal; and
calculating an ACI value based on the RSSI and the estimated amount of power in the digital signal.

11. The method of claim 10, further comprising:
receiving a second signal via the wireless communication channel;
determining whether ACI is present in the second signal based at least in part on whether the ACI value exceeds a threshold value; and
configuring the ADC to sample the second signal at one of the plurality of sampling rates based at least in part on whether ACI is determined to be present in the second signal.

12. A wireless communication device, comprising:
a processing system; and
a memory storing instructions that, when executed by the processing system, cause the wireless communication device to:
receive a first signal via a wireless communication channel;
determine whether adjacent channel interference (ACI) is present in the first signal based on one or more signals previously received by the wireless communication device via the wireless communication channel; and
configure an analog-to-digital converter (ADC) to sample the first signal at one of a plurality of sampling rates based at least in part on whether ACI is determined to be present in the first signal, the ADC producing a digital signal based on the sampling of the first signal.

13. The wireless communication device of claim 12, wherein the configuring of the ADC comprises:
configuring the ADC to sample the first signal at a first sampling rate of the plurality of sampling rates responsive to determining that ACI is present in the first signal; and
configuring the ADC to sample the first signal at a second sampling rate of the plurality of sampling rates responsive to determining that ACI is not present in the first signal, the second sampling rate being lower than the first sampling rate.

14. The wireless communication device of claim 13, wherein execution of the instructions further causes the wireless communication device to:
selectively filter the digital signal via a digital filter based on whether the ADC is configured to sample the first signal at the first sampling rate or the second sampling rate, the digital filter being configured to remove ACI in the digital signal.

15. The wireless communication device of claim 13, wherein execution of the instructions further causes the wireless communication device to:
detect a packet carried on the first signal; and
adjust a sampling rate of the ADC responsive to detecting the packet.

16. The wireless communication device of claim 15, wherein the adjusting of the sampling rate of the ADC comprises:
changing the sampling rate of the ADC from the second sampling rate to the first sampling rate.

17. The wireless communication device of claim 15, wherein the packet comprises a physical layer convergence protocol (PLCLP) protocol data unit (PPDU) having a legacy short training field (L-STF), and the sampling rate of the ADC is adjusted responsive to detecting the L-STF.

18. The wireless communication device of claim 12, wherein the first signal is filtered via a low-pass filter, execution of the instructions further causing the wireless communication device to:
configure a bandwidth of the low-pass filter based on whether ACI is determined to be present in the first signal.

19. The wireless communication device of claim 12, wherein execution of the instructions further causes the wireless communication device to:
determine a received signal strength indication (RSSI) associated with the first signal;
estimate an amount of power in the digital signal; and
calculate an ACI value based on the RSSI and the estimated amount of power in the digital signal.

20. The wireless communication device of claim 19, wherein execution of the instructions further causes the wireless communication device to:
receive a second signal via the wireless communication channel;
determine whether ACI is present in the second signal based at least in part on whether the ACI value exceeds a threshold value; and
configure the ADC to sample the second signal at one of the plurality of sampling rates based at least in part on whether ACI is determined to be present in the second signal.
